(19) United States
(12) Patent Application Publication
(10) Pub. No.: US 2010/0049788 A1
(43) Pub. Date: Feb. 25, 2010

(54) MEDIA SHARING USING LOCAL APPLICATION

(75) Inventors: Mohana Krishna Bandaru, Sunnyvale, CA (US); Hong Quang Bui, Capo Beach, CA (US)

Correspondence Address: BLACK LOWE & GRAHAM, PLLC, 701 FIFTH AVENUE, SUITE 4800, SEATTLE, WA, 98104, US

(73) Assignee: MEMEO, INC., Aliso Viejo, CA (US)

(21) Appl. No.: 12/511,791

(22) Filed: Jul. 29, 2009

Related U.S. Application Data
(60) Provisional application No. 61/084,390, filed on Jul. 29, 2008.

(51) Int. Cl. G06F 15/16

(52) U.S. Cl. 709/203; 709/219

(57) ABSTRACT

A system includes a server and a source client executable on a first electronic device configured to be in communication over a network with the server.

### CROSS-REFERENCE TO RELATED APPLICATIONS

This application claims priority from U.S. Provisional App. No. 61/084,390, filed Jul. 29, 2008, and entitled “MEDIA SHARING WITH INSTANTANEOUS SUPER-SOCIAL NETWORKS,” which is hereby incorporated by reference as if fully set forth herein.

### BACKGROUND

Many consumers have built extensive profiles on leading social internet sites. Many of these sites have their own lexicon and methods of communication and notification. Moving away from those paradigms is a major pain point. Moreover, locally running native personal computer applications have access to rich media that is often highly personal and unique to the end-user. A mechanism that bridges these two worlds will instantly create a super-large network that offers no-compromise access to the users' online social clouds and local personal media, such as pictures and videos.

Previously, one would need to move their local media files to a remote server before being able to share them. The recipients would then only be able to access those files from that same remote server. If the user's personal social group included people enrolled in multiple websites, the user will often have to move the files to each website using that site's unique upload mechanisms. Moreover, the recipient's experience would be different based on each website's particular capabilities.

Sometimes, the sharer will just send their media to one particular site and then require each recipient to go to that site and create a new user identity to even preview that content.

It is generally a very complicated and onerous process to share the same media files with multiple sites, and doing so would require installing and using multiple different uploaders unique to each site.

Sharing media with a group of people enrolled in different social networks would require multiple steps.

Recipients often do not have the option to preview shared files without creating another user identity.

### BRIEF DESCRIPTION OF THE DRAWINGS

Preferred and alternative embodiments of the present invention are described in detail below with reference to the following drawings.

FIG. 1 illustrates a system according to an embodiment of the invention;

FIG. 2 is a schematic block diagram of functionality according to an embodiment of the invention; and

FIG. 3 illustrates a GUI according to an embodiment of the invention.

### DETAILED DESCRIPTION OF THE PREFERRED EMBODIMENT

In an embodiment, end users are able to leverage their existing electronic social networks within new desktop applications, instantaneously creating a very large, super-social network that now has direct access to the users' local computer storage and computing power.

Using a central site to broker the connection between a local application and remote websites allows many advantages, among them:

a. Ability to preview the files on the central broker's site.

b. Ability for the recipient to experience the shared content within the native context of their chosen social website (which they self-select).

Some of the advantages may include not requiring end users to recreate their social networks by creating yet another address book on the local application. Moreover, the recipients are notified of the activity directly within the application they're already using. By including a central broker server 104, the local applications do not need to know how to directly speak with the account-based websites and can access new ones anytime the broker server 104 is updated. Both senders and recipients do not need to recreate their social graph and can seamlessly enjoy media sharing between their local computers and their existing online friend networks.

An embodiment includes a set of web/application servers that contain logic enabling them to communicate directly with 3rd party social websites. An embodiment may also include logic that abstracts those 3rd party sites' APIs by providing a unified, single API, or program interface. A client application is able to speak to the broker via its own API which then issues commands on the remote servers on behalf of the person using the client. This API may be created and implemented by the central broker. It acts as a mediator and abstraction layer between the client applications and the 3^{rd} party sites.

Embodiments of the invention may be described in the general context of computer-executable instructions, such as program modules, executed by one or more computer processors or other devices, computer-readable media on which such instructions are stored, and/or the processors/devices themselves. Generally, program modules include routines, programs, objects, components, data structures, etc. that perform particular tasks or implement particular abstract data types. Typically the functionality of the program modules may be combined or distributed as desired in various embodiments.

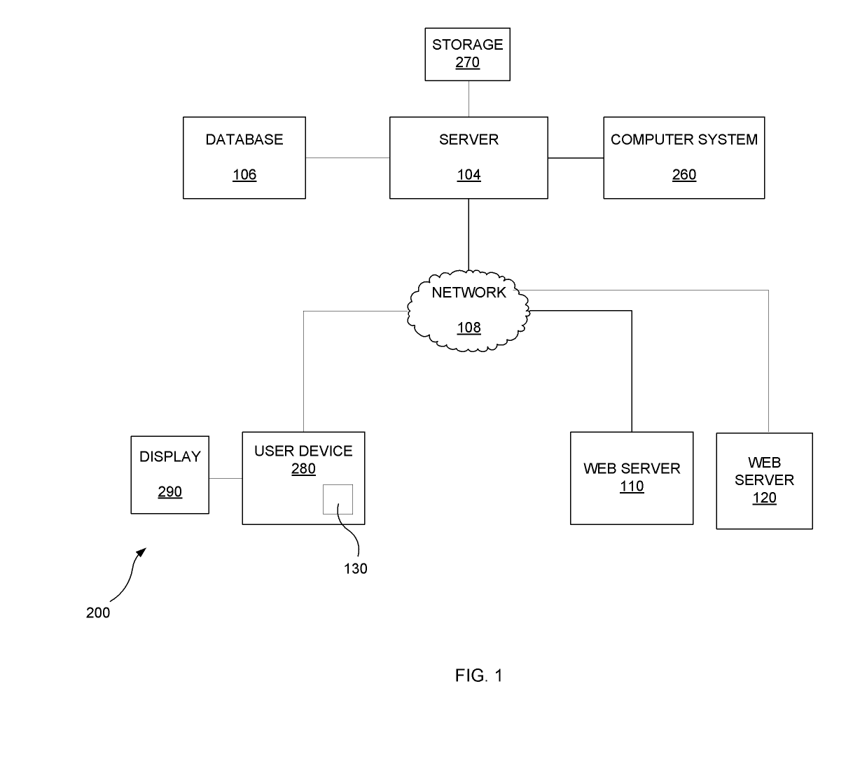

FIG. 1 illustrates a system 200 according to an embodiment of the invention and/or in which an embodiment of the invention may be implemented. Elements of the system 200 illustrated in FIG. 1 may include or otherwise utilize at least some form of computer readable media, which may be associated with one or more processors and/or memory devices. Computer readable media can be any available media that can be accessed by one or more components of such operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by one or more components of such operating environment. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

Referring again to FIG. 1, an embodiment of the present invention can be described in the context of an exemplary computer network system 200 as illustrated. System 200 includes an electronic user device 280, such as a personal computer, workstation or other processing device (e.g., personal digital assistants, mobile/cellular telephones, etc.), that are linked via a communication medium, such as a network 108 (e.g., WiFi, LAN, Internet, WiMax, etc.), to an electronic device or system, such as a server 104 (broker server). The server 104 may further be coupled, or otherwise have access, to a database 106, electronic storage 270 and a computer system 260. Although the embodiment illustrated in FIG. 1 includes one server 104 coupled to one user device 280 via the network 108, it should be recognized that embodiments of the invention may be implemented using two or more such user devices coupled to two or more such servers.

In an embodiment, user device 280 may include or may be otherwise coupled to a computer screen or display 290. User device 280 can be used for various purposes including both network- and local-computing processes.

The user device 280 is linked via the network 108 to server 104 so that computer programs, such as, for example, a client application 130 running on the user device 280, can cooperate in two-way communication with server 104. The client application 130 can be transmitted to user device 280 over the network 108 from the server 104 or other device for subsequent installation on user device 280.

Server 104 may be coupled to database 106 and/or electronic storage 270 to retrieve information therefrom and to store information thereto. Additionally, the server 104 may be coupled to the computer system 260 in a manner allowing the server to delegate certain processing functions to the computer system.

In an embodiment, the broker server 104 is in communication over the network 108 with a plurality of web-content servers 110, 120. The web-content servers 110, 120 are configured to host well-known account-based social-networking sites such as, for example, Facebook.

The user device 280 has stored thereon a plurality of electronic files (e.g., digital photographs, digital music files, digital documents, etc.). The source client 130 is configured to present on display 290 a graphical user interface operable to receive from a user a selection of an electronic file or files for sharing with account holders associated with the sites hosted by servers 110, 120. The broker server 104 is configured to provide, via the plurality of account-based sites, the selected file to one or more such account holders in response to a single command by the user. Such single command may merely be the user's selection of the file(s) to be shared, or may be a command issued after file selection. The broker server 104 is configured to provide the selected file(s) without requiring the user of user device 280 to access any of the plurality of account-based sites using, in a conventional manner, a browser application.

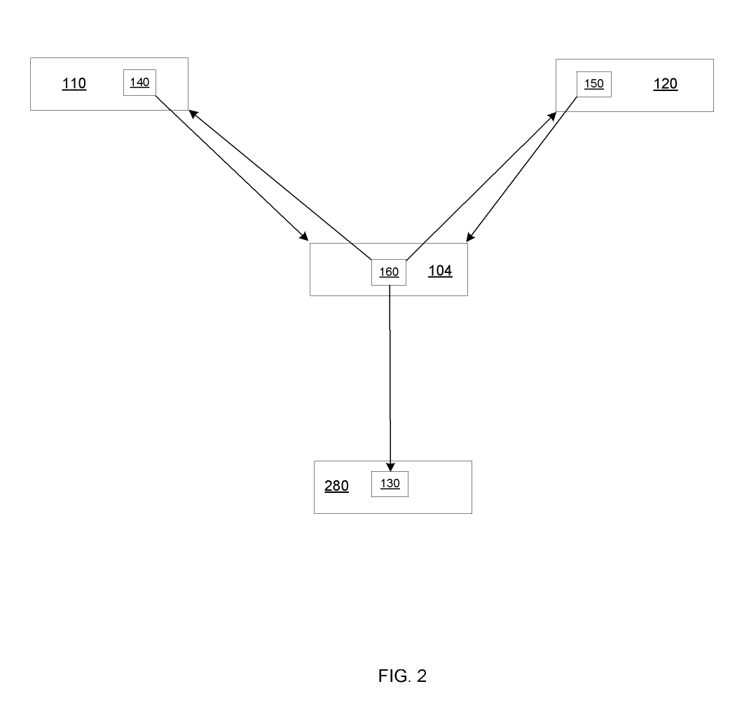

In an embodiment, and referring to FIG. 2, the secure broker server 104 includes logic enabling it to interact directly with the account-based websites hosted by web-content servers 110, 120. More specifically, the broker server 104 includes logic that implements the published APIs 140, 150 of the account-based websites enabling the broker server 104 to interact directly with them. This implementation may include any necessary security-token exchanges.

An API 160 on the broker server 104 enables local applications, or other websites, to talk to the central broker. More specifically, a separate API 160 implemented and published on the broker server 104 itself, in turn, enables the account-based websites and/or applications, such as the source client 130, to interact directly with the broker server 104 on a proactive basis.

A set of configuration information and parameters may be exchanged between the broker server 104 and the source client 130 using its API 160 to allow the source client 130 to discover which services associated with the account-based websites the source client 130 can communicate with and their notable unique characteristics. The configuration parameters include information pertinent to validating the identity of the user of the source client 130, version information about the broker server 104 and the source client 130, and which services this particular user and application have been authorized/provisioned to access.

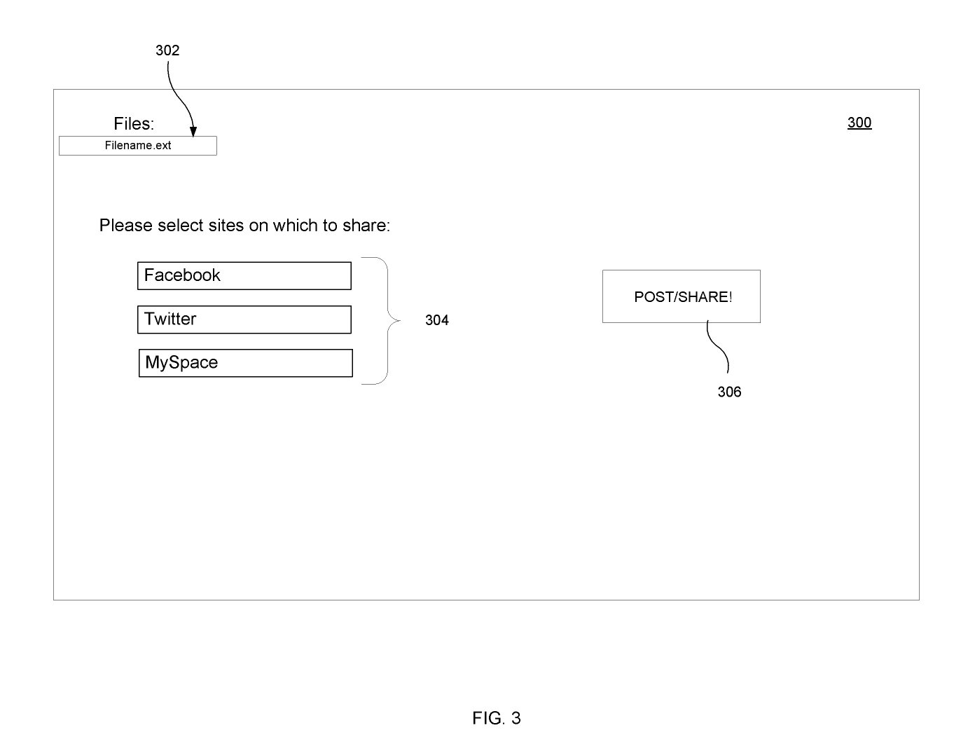

Referring to FIG. 3, the source client 130 can present a user interface 300, displayable, for example, on display 290, that includes a list 304 of available account-based websites to which the user may post/share a selected electronic file, as may be indicated in a list 302, as well as options available to a user. The options may include any type of customization parameters, as well as security tokens that provide access. After selecting the sites with which to share, the user may select a post button 306 to instruct the source client 130, in conjunction with the server 104, to share the selected files. Alternatively, the user may share the selected file(s) with a predetermined set of the account-based websites, selected by the user, simply by making the file selections or by selecting the post button 306.

The end-user can select the sites they're enrolled in and/or wish to share with, enter their credentials (or otherwise allow access), on a one-time basis in an embodiment, and then interact with the account-based websites directly via the source client 130.

For example, a PC media sharing application can allow a user to share pictures with their Facebook friends directly within the application. The user can even select notification mechanisms unique to Facebook, such as posting messages to the Wall or to Poke someone. The recipients will receive the notification within their existing Profile thereby fully integrating with Facebook's existing schema. The recipient, likewise, could select to install on his/her device a Facebook custom application, similar to the source client 130, that interacts with the broker server 104 server and enjoy the shared media files directly within Facebook.

Exemplary media sharing applications may include a photo or video sharing application.

While a preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A system, comprising:
a broker server, the broker server in communication over a network with at least one web-content server, the at least one web-content server configured to host a plurality of account-based sites; and
a source client executable on a first electronic device configured to be in communication over a network with the broker server, the first electronic device having stored thereon a plurality of electronic files, the source client configured to receive from a first user of the first electronic device a selection of a file of the plurality of files,
wherein the broker server is configured to provide, via the plurality of account-based sites, the selected file to at least one second user of the plurality of account-based sites in response to a single command by the first user and without requiring the first user to access any of the plurality of account-based sites using a browser application.

2. A method of transferring a computer program product from at least one first computer to at least one second computer connected to the at least one first computer through a communication medium, the method comprising the steps of:
(a) accessing, on the at least one first computer, computer-executable instructions that, when executed on a data-processing system having stored thereon a plurality of electronic files, enable the processing system to perform at least the steps of:
(1) receiving from a first user of the processing system a selection of a file of the plurality of files, and
(2) providing to a broker server a single command received from the first user, the broker server in communication over a network with at least one web-content server, the at least one web-content server configured to host a plurality of account-based sites, the single command operable to cause the broker server to provide, via the plurality of account-based sites, the selected file to at least one second user of the plurality of account-based sites without requiring the first user to access any of the plurality of account-based sites using a browser application; and
(b) transferring the computer-executable instructions from the at least one first computer to the at least one second computer through the communications medium.
